(19) United States
(12) Patent Application Publication
(10) Pub. No.: US 2002/0095446 A1
(43) Pub. Date: Jul. 18, 2002

(54) System for converting a scanned image to an original document

(76) Inventor: Sumit Gupta, Newark, CA (US)

Correspondence Address: J.D. Harriman II,, COUDERT BROTHERS,, 333 South Hope Street, 23rd Floor, Los Angles, CA, 90071, US

(21) Appl. No.: 09/764,770

(22) Filed: Jan. 16, 2001

(51) Int. Cl. G06F 15/00; G06F 17/00; G06F 17/21; G06F 17/24

(52) U.S. Cl. 707/517

(57) ABSTRACT

The present invention provides a system for converting a scanned image into an original document. According to the present invention, a standard document format is defined which includes specific fonts, font sizes, alignment tags, tabs, margins and other formatting information such as table definitions and picture definitions, for instance. Then, a scanner with the appropriate OCR software converts the document back to its original electronic format using the standard document format.

### BACKGROUND OF THE INVENTION

1. Field of the Invention

The present invention relates to a system for converting a scanned image to an original document.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

Sun, Sun Microsystems, the Sun logo, Solaris and all Java-based trademarks and logos are trademarks or registered trademarks of Sun Microsystems, Inc. in the United States and other countries. All SPARC trademarks are used under license and are trademarks of SPARC International, Inc. in the United States and other countries. Products bearing SPARC trademarks are based upon an architecture developed by Sun Microsystems, Inc.

2. Background Art

Documents typically are either used electronically or they are printed out and a physical copy of the document is used. When a document is printed out and a physical copy is used, the electronic version of the document is eventually lost. The physical copy of the document is often hard to maintain and once the electronic copy is lost, it is hard to send the physical copy of the document to another person, even if it is maintained.

One solution is to use a scanner. A scanner is a device that is configured to obtain an image of the document and to transform the image into a computer readable form, called a bitmap. The bitmap is a representation of the patterns in the original document. A bitmap, however, is disadvantageous because it is only a representation of the patterns in the document and does not contain letters, numbers, tables, and other information associated with the document that can be modified and used by either the sender or the recipient of the document.

Optical Character Recognition

To partially solve this dilemma, one solution is to use optical character recognition (OCR). OCR allows a user to take a physical copy of a document, to scan it using a conventional scanner, and to convert the scanned image into a text file with errors using OCR technology. To convert the scanned image to a text file, the OCR software looks at the document and attempts to determine the letters and numbers in the image.

OCR technology, however, does not allow a user to retrieve the original document and there is no standard for using OCR. OCR simply tries to define the appearance of letters and numbers in a generic way and does not account for variations in the appearance of letters and numbers when using different fonts. As such, OCR mayor may not be successful in converting an image to a text file having letters, numbers, and other information.

### SUMMARY OF THE INVENTION

The present invention relates to a system for converting a scanned image into an original document. According to the present invention, a standard document format is defined which includes specific fonts, font sizes, alignment tags, tabs, margins and other formatting information such as table definitions and picture definitions, for instance. Then, a scanner with the appropriate OCR software converts the document back to its original electronic format using the standard document format.

In one embodiment of the present invention, the formatting standards are placed in the document by either the software that created the document or the software that converts the electronic document to a physical copy, such as a printer. In one embodiment, the formatting standards are marks on one side of the paper to define its alignment and other document attributes. In another embodiment, the formatting standards are in the form of bar codes.

Also the scanner hardware/software may define the fonts which it recognizes and these fonts may be used in the document. In this way, the document format of the present invention is completely understood from a scanned image, and hence, it may be converted back to the original document.

### BRIEF DESCRIPTION OF TEE DRAWINGS

These and other features, aspects and advantages of the present invention will become better understood with regard to the following description, appended claims and accompanying drawings where:

FIG. 1 is a flowchart describing a system for converting a scanned image to an electronic document according to an embodiment of the present invention.

FIG. 2 is a diagram describing a system for implementing one or more embodiments of the present invention.

FIG. 3 is a flowchart describing a system for converting a scanned image to an electronic document according to another embodiment of the present invention.

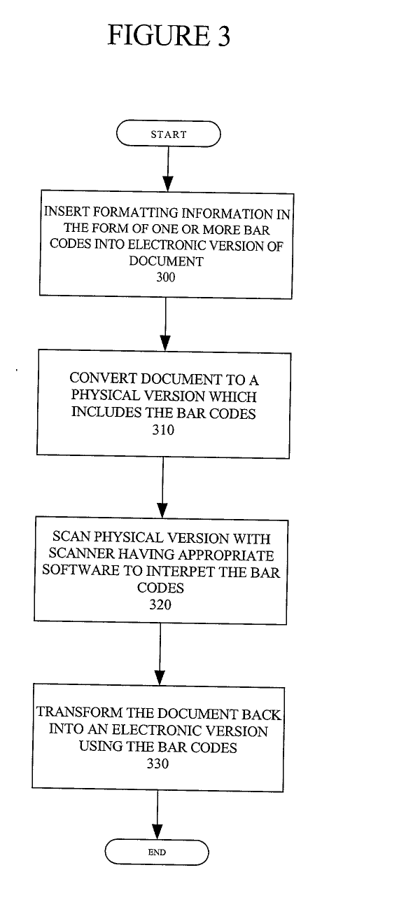

FIG. 4 is a diagram of a physical version of a document according to an embodiment of the present invention.

FIG. 5 is a flowchart describing a system for converting a scanned image to an electronic document according to another embodiment of the present invention.

FIG. 6 is an embodiment of a computer execution environment suitable for the present invention.

### DETAILED DESCRIPTION OF THE INVENTION

The invention relates to a system for converting a scanned image to an original document. In the following description, numerous specific details are set forth to provide a more thorough description of embodiments of the invention. It will be apparent, however, to one skilled in the art, that the invention may be practiced without these specific details. In other instances, well known features have not been described in detail so as not to obscure the invention.

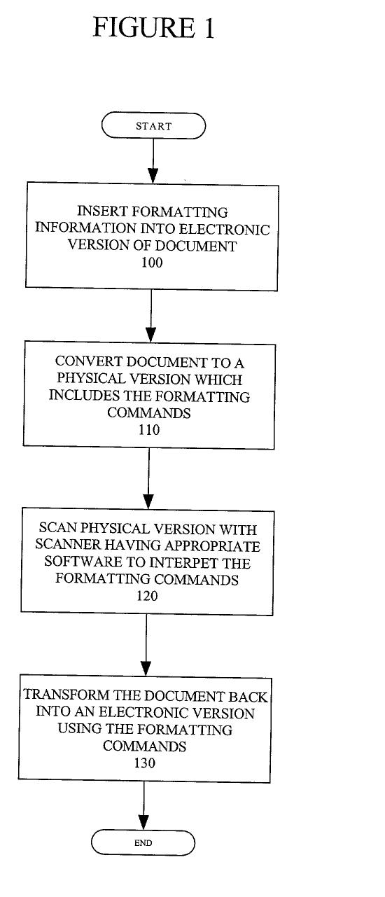

According to the present invention, a standard document format is defined which includes Formatting standards, such as specific fonts, font sizes, alignment tags, tabs, margins and other formatting information such as table definitions and picture definitions, for instance. Then, a Scanner with the appropriate OCR software converts the document back to its original electronic format using the standard document format. One embodiment of the present invention is shown in FIG. 1.

At step 100, an electronic version of a document has formatting information inserted into it. Then, at step 110, the document is converted to a physical version which includes the formatting commands. Next, at step 120, the document is scanned by a scanner implementing the appropriate OCR software to interpret the formatting commands. Thereafter, at step 130, the document is transformed back into an electronic version by the scanner using the formatting commands.

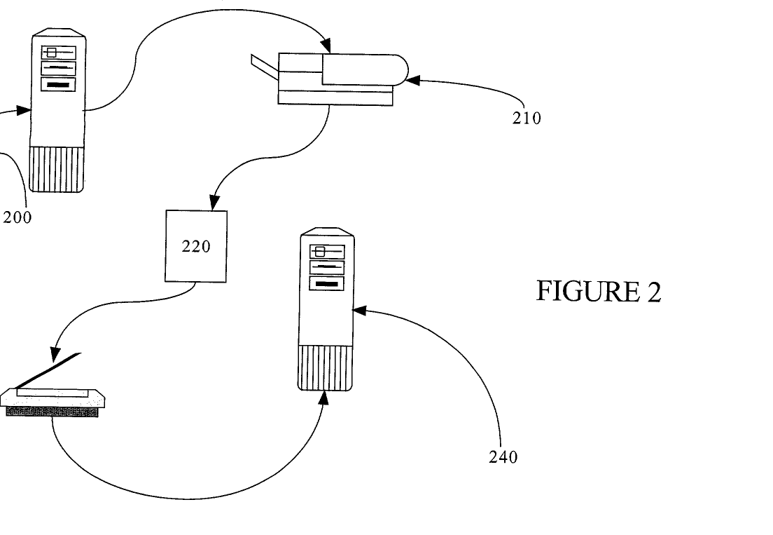

One embodiment of a system configured to implement the present invention is shown in the diagram of FIG. 2. Computer system 200 is used to create an electronic version of a document and to insert formatting commands into the document. Then, printer 210 is used to transform the electronic document into a physical document 220 with the formatting commands in the document. Note that in one embodiment, printer 210 inserts the formatting commands rather than computer system 200. Next, scanner 230 is used to transform the physical document 220 into an electronic document again using the formatting commands and appropriate OCR software for use in computer system 240. In one embodiment, computer systems 200 and 240 are the same computer system.

In one embodiment of the present invention, the formatting standard is implemented by placing marks on one side of the paper to define its alignment and other document attributes. In another embodiment of the present invention, the formatting standards are inserted into the document in the form of bar codes. This embodiment of the present invention is shown in Figure

At step 300, an electronic version of a document has formatting information in the form of one or more bar codes inserted into it, for instance when the software used to generate or print the document is initiated. Then, at step 310, the document is converted to a physical version which includes the bar codes, for instance using a printer. Next, at step 320, the document is scanned by a scanner implementing the appropriate OCR software to interpret the bar codes. Thereafter, at step 330, the document is transformed back into an electronic version by the scanner using the bar codes.

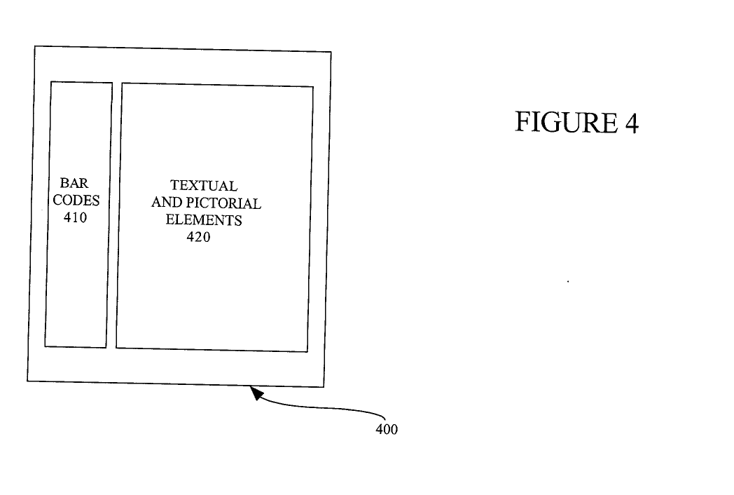

The embodiment of the present invention where bar codes are used is shown in connection with the block diagram of FIG. 4. In FIG. 4, the physical version of the document 400 is divided up into two main portions. The first portion comprises bar codes 410. The second portion comprises the textual and pictorial elements of the physical version 420.

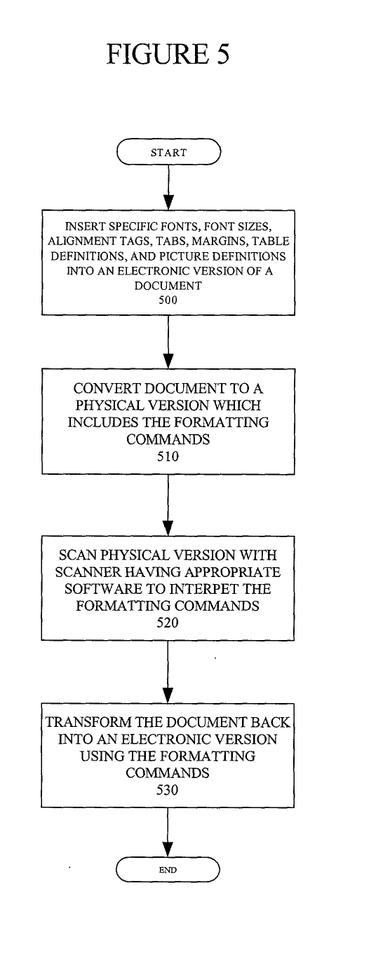

Another embodiment of the present invention is shown in FIG. 5. At step 500, an electronic version of a document has specific fonts, font sizes, alignment tags, tabs, margins, table definitions, and picture definitions inserted into it. Then, at step 510, the document is converted to a physical version which includes the formatting commands inputted at step 500. Next, at step 520, the document is scanned by a scanner implementing the appropriate OCR software to interpret the formatting commands. Thereafter, at step 530, the document is transformed back into an electronic version by the scanner using the formatting commands.

Also the scanner hardware/software may define the fonts which it recognizes and these fonts may be used in the document. In this way, the document format of the present invention is completely understood from a scanned image, and hence, it may be converted back to the original document.

Embodiment of Computer Execution Environment (Hardware)

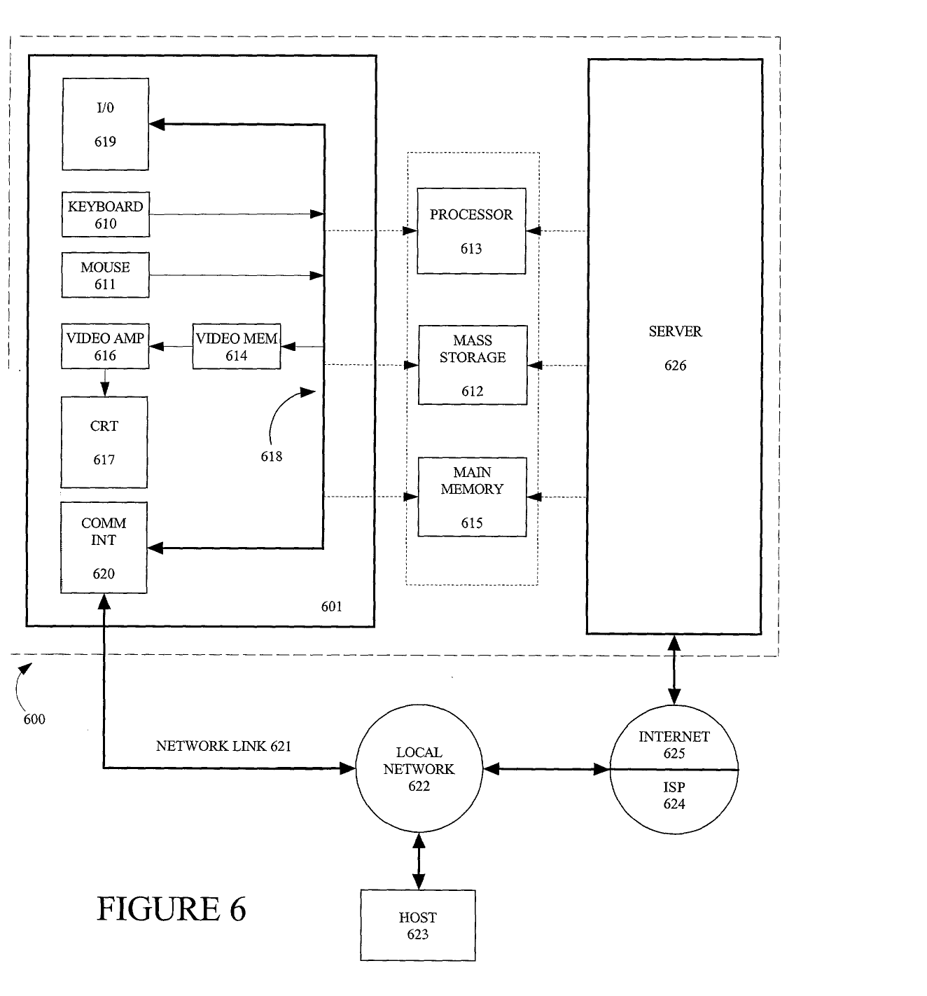

An embodiment of the invention can be implemented as computer software in the form of computer readable program code executed in a general purpose computing environment such as environment 600 illustrated in FIG. 6, or in the form of bytecode class files executable within a java™ run time environment running in such an environment, or in the form of bytecodes running on a processor (or devices enabled to process bytecodes) existing in a distributed environment (e.g., one or more processors on a network). A keyboard 610 and mouse 611 are coupled to a system bus 618. The keyboard and mouse are for introducing user input to the computer system and communicating that user input to central processing unit (CPU) 613. Other suitable input devices may be used in addition to, or in place of, the mouse 611 and keyboard 610. I/O (input/output) unit 619 coupled to bidirectional system bus 618 represents such I/O elements as a printer, A/V (audio/video) I/O, etc.

Computer 601 may include a communication interface 620 coupled to bus 618. Communication interface 620 provides a two-way data communication coupling via a network link 621 to a local network 622. For example, if communication interface 620 is an integrated services digital network (ISDN) card or a modem, communication interface 620 provides a data communication connection to the corresponding type of telephone line, which comprises part of network link 621. If communication interface 620 is a local area network (LAN) card, communication interface 620 provides a data communication connection via network link 621 to a compatible LAN. Wireless links are also possible. In any such implementation, communication interface 620 sends and receives electrical, electromagnetic or optical signals which carry digital data streams representing various types of information.

Network link 621 typically provides data communication through one or more networks to other data devices. For example, network link 621 may provide a connection through local network 622 to local server computer 623 or to data equipment operated by ISP 624. ISP 624 in turn provides data communication services through the world wide packet data communication network now commonly referred to as the “Internet” 625. Local network 622 and Internet 625 both use electrical, electromagnetic or optical signals which carry digital data streams. The signals through the various networks and the signals on network link 621 and through communication interface 620, which carry the digital data to and from computer 600, are exemplary forms of carrier waves transporting the information.

Processor 613 may reside wholly on client computer 601 or wholly on server 626 or processor 613 may have its computational power distributed between computer 601 and server 626. Server 626 symbolically is represented in FIG. 6 as one unit, but server 626 can also be distributed between multiple “tiers”. In one embodiment, server 626 comprises a middle and back tier where application logic executes in the middle tier and persistent data is obtained in the back tier. In the case where processor 613 resides wholly on server 626, the results of the computations performed by processor 613 are transmitted to computer 601 via Internet 625, Internet Service Provider (ISP) 624, local network 622 and communication interface 620. In this way, computer 601 is able to display the results of the computation to a user in the form of output.

Computer 601 includes a video memory 614, main memory 615 and mass storage 612, all coupled to bi-directional system bus 618 along with keyboard 610, mouse 611 and processor 613. As with processor 613, in various computing environments, main memory 615 and mass storage 612, can reside wholly on server 626 or computer 601, or they may be distributed between the two. Examples of systems where processor 613, main memory 615, and mass storage 612 are distributed between computer 601 and server 626 include the thin-client computing architecture developed by Sun Microsystems, Inc., the palm pilot computing device and other personal digital assistants, Internet ready cellular phones and other Internet computing devices, and in platform independent computing environments, such as those which utilize the Java technologies also developed by Sun Microsystems, Inc.

The mass storage 612 may include both fixed and removable media, such as magnetic, optical or magnetic optical storage systems or any other available mass storage technology. Bus 618 may contain, for example, thirty-two address lines for addressing video memory 614 or main memory 615. The system bus 618 also includes, for example, a 32-bit data bus for transferring data between and among the components, such as processor 613, main memory 615, video memory 614 and mass storage 612. Alternatively, multiplex data/address lines may be used instead of separate data and address lines.

In one embodiment of the invention, the processor 613 is a microprocessor manufactured by Motorola, such as the 680X0 processor or a microprocessor manufactured by Intel, such as the 80×86, or Pentium processor, or a SPARC microprocessor from Sun Microsystems, Inc. However, any other suitable microprocessor or microcomputer may be utilized. Main memory 615 is comprised of dynamic random access memory (DRAM). Video memory 614 is a dual-ported video random access memory. One port of the video memory 614 is coupled to video amplifier 616. The video amplifier 616 is used to drive the cathode ray tube (CRT) raster monitor 617. Video amplifier 616 is well known in the art and may be implemented by any suitable apparatus. This circuitry converts pixel data stored in video memory 614 to a raster signal suitable for use by monitor 617. Monitor 617 is a type of monitor suitable for displaying graphic images.

Computer 601 can send messages and receive data, including program code, through the network(s), network link 621, and communication interface 620. In the Internet example, remote server computer 626 might transmit a requested code for an application program through Internet 625, ISP 624, local network 622 and communication interface 620. The received code maybe executed by processor 613 as it is received, and/or stored in mass storage 612, or other non-volatile storage for later execution. In this manner, computer 600 may obtain application code in the form of a carrier wave. Alternatively, remote server computer 626 may execute applications using processor 613, and utilize mass storage 612, and/or video memory 615. The results of the execution at server 626 are then transmitted through Internet 625, ISP 624, local network 622 and communication interface 620. In this example, computer 601 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Thus, a system for converting a scanned image to an original document is described in conjunction wit one or more specific embodiments. The invention is defined by the claims and their full scope of equivalents.

1. A method for converting a physical document into an electronic document comprising:
inserting one or more formatting commands into an initial electronic document;
converting said initial electronic document into a physical document;
scanning said physical document using a scanner to produce an electronic document wherein said scanner is configured to interpret said formatting commands.

2. The method of claim 1 wherein said formatting commands are fonts.

3. The method of claim 1 wherein said formatting commands are font sizes.

4. The method of claim 1 wherein said formatting commands are alignment tags.

5. The method of claim 1 wherein said formatting commands are tabs.

6. The method of claim 1 wherein said formatting commands are margins.

7. The method of claim 1 wherein said formatting commands are table definitions.

8. The method of claim 1 wherein said formatting commands are picture definitions.

9. The method of claim 1 wherein said step of converting further comprises:
placing one or more bar codes into said physical document.

10. A computer program product comprising:
a computer usable medium having computer readable program code embodied therein configured to convert a physical document into an electronic document, said computer program product comprising:
computer readable code configured to cause a computer to insert one or more formatting commands into an initial electronic document;
computer readable code configured to cause a computer to convert said initial electronic document into a physical document;
computer readable code configured to cause a computer to scan said physical document using a scanner to produce an electronic document wherein said scanner is configured to interpret said formatting commands.

11. The computer program product of claim 10 wherein said formatting commands are fonts.

12. The computer program product of claim 10 wherein said formatting commands are font sizes.

13. The computer program product of claim 10 wherein said formatting commands are alignment tags.

14. The computer program product of claim 10 wherein said formatting commands are tabs.

15. The computer program product of claim 10 wherein said formatting commands are margins.

16. The computer program product of claim 10 wherein said formatting commands are table definitions.

17. The computer program product of claim 10 wherein said formatting commands are picture definitions.

18. The computer program product of claim 10 wherein said computer readable code configured to cause a computer to convert further comprises:
computer readable code configured to cause a computer to place one or more bar codes into said physical document.
